(19) United States
(12) Patent Application Publication
(10) Pub. No.: US 2024/0425942 A1
(43) Pub. Date: Dec. 26, 2024

(54) METHOD FOR PRODUCING AGGLOMERATED RAW MATERIAL

(71) Applicant: JFE STEEL CORPORATION, Tokyo (JP)

(72) Inventors: Kenta TAKEHARA, Tokyo (JP); Takahide HIGUCHI, Tokyo (JP); Takeru HOSHINO, Tokyo (JP)

(73) Assignee: JFE STEEL CORPORATION, Tokyo (JP)

(21) Appl. No.: 18/693,762

(22) PCT Filed: Jul. 11, 2022
(86) PCT No.: PCT/JP2022/027240

§ 371 Date: Mar. 20, 2024

(30) Foreign Application Priority Data
Sep. 29, 2021 (JP) 2021-158957

(51) Int. Cl. C21B 13/00; C21B 13/12

(52) U.S. Cl. CPC C21B 13/0046; C21B 13/12

(57) ABSTRACT

A method for producing an agglomerated raw material includes pressing and heating a raw material containing iron oxide having a particle size smaller than a preset particle size, thereby agglomerating the raw material. The raw material contains the iron oxide in an amount of more than 50% by mass, and the raw material is heated by electrical heating.

### TECHNICAL FIELD

This application relates to a method for producing an agglomerated raw material, which involves agglomerating a raw material containing powdered iron oxide.

### BACKGROUND

When a raw material containing powdered iron oxide is used in a pig iron production process, which involves gas reduction of a raw material using a blast furnaces, a shaft furnace, or the like, it is necessary to agglomerate the raw material containing powdered iron oxide in order to ensure gas permeability in the furnace. As a technique for agglomerating a powdered raw material, Non-Patent Literature 1 describes a production method which involves agglomerating a powdered raw material, either in a powdery or granular form, whose melting point or decomposition temperature and sintering temperature are close to each other. In the production method, silicon nitride is used as the powdered raw material, and the powdered raw material is agglomerated by a hot press which presses the powdered raw material while heating it. The heating of the powdered raw material by the hot press is performed by heating a mold filled with the powdered raw material. Non-Patent Literature 1 states that the mold may be heated by a resistance heating method, an induction heating method, or the like. The heating temperature of silicon nitride as the powdered raw material is set at 1800° C., which is close to 1900° C. which is the melting point of silicon nitride or the temperature at which silicon nitride begins to decompose. Further, the pressure applied to silicon nitride in the hot press is set at 10 atmospheres. The literature states that such a hot-press method can sinter silicon nitride without melting it.

### CITATION LIST

### Non-Patent Literature

NPL 1: Yoneya, M., “Pressure Application Technology for Sintering of Ceramics”, Journal of High Pressure Institute of Japan, 1992, vol 30, no. 2, pp. 60-68

### SUMMARY

### Technical Problem

As described above, in the method described in Non-Patent Literature 1, silicon nitride as a powdered raw material is heated to the melting point or decomposition temperature of silicon nitride while it is being pressed. Since the heating temperature is high, the method described in Non-Patent Literature 1 may consume a large amount of energy when agglomerating silicon nitride. Also, when agglomerating a raw material for use in a blast furnace or a shaft furnace, it is preferred to perform the agglomeration at a temperature lower than conventional methods, and as low as possible.

This application has been made to solve the above problem. It is therefore an object of the disclosure to provide an agglomerated raw material production method which can agglomerate a raw material at a lower temperature than the conventional methods, thereby reducing energy consumption.

### Solution to Problem

The present disclosure for solving the above problem can be embodied as follows.
[1] A method for producing an agglomerated raw material, including pressing and heating a raw material containing iron oxide having a particle size smaller than a preset particle size, thereby agglomerating the raw material, wherein the raw material contains the iron oxide in an amount of more than 50% by mass, and wherein the raw material is heated by electrical heating.
[2] The method for producing an agglomerated raw material described in [1], wherein the raw material contains 10% by mass or more of a metal which deforms plastically.
[3] The method for producing an agglomerated raw material described in [2], wherein the raw material is agglomerated by heating it at 700° C. or more while pressing it at 20 MPa or more.
[4] The method for producing an agglomerated raw material described in [2] or [3], wherein the metal has an electrical conductivity of 11×10⁶ S/m or more.
[5] A method for producing an agglomerated raw material, including pressing and heating a raw material containing iron oxide having a particle size smaller than a preset particle size, thereby agglomerating the raw material, wherein the raw material contains the iron oxide in an amount of more than 50% by mass, and wherein a pressure upon the pressing and a temperature upon the heating satisfy the following inequality (1):

$$P \geq 40 - ( T - 900 ) / 10 \qquad ( 1 )$$

where P is the pressure (MPa), and T is the temperature (° C.).
[6] The method for producing an agglomerated raw material described in [5], wherein when the heating of the raw material is electrical heating, the pressure and the temperature satisfy the following inequality (2) instead of the inequality (1):

$$P \geq 40 - ( T - 700 ) / 10 \qquad ( 2 )$$

where P is the pressure (MPa), and T is the temperature (° C.).
[7] The method for producing an agglomerated raw material described in [5], wherein the raw material contains 10% by mass or more of a metal which deforms plastically and has an electrical conductivity of 11×10⁶ S/m or more, and wherein when the heating of the raw material is electrical heating, the pressure and the temperature satisfy the following inequality (3) instead of the inequality (1):

$$P \geq 40 - ( T - 500 ) / 10 \qquad ( 3 )$$

where P is the pressure (MPa), and T is the temperature (° C.).

### Advantageous Effects

According to the disclosure, a raw material containing iron oxide can be agglomerated at a lower temperature than the conventional methods, thus enabling an overall reduction in energy consumption.

### BRIEF DESCRIPTION OF DRAWINGS

FIG. 1 is a diagram schematically showing an example of a double-roll type pressure device to which an agglomerated raw material production method according to an embodiment of the disclosure can be applied.

FIG. 2 is a diagram showing a mold used in Experimental Examples.

### DESCRIPTION OF EMBODIMENTS

An agglomerated raw material production method according to an embodiment of the disclosure is a production method which involves agglomeration of a raw material containing more than 50% by mass of iron oxide having a particle size smaller than a preset particle size (hereinafter referred to as “the raw material”). It is also a production method which, by agglomerating the raw material, allows it to be used as a raw material in a pig iron production process using, for example, a blast furnace or a shaft furnace. The preset particle size is a size suited for a raw material for use in a pig iron production process using a blast furnace or a shaft furnace. In particular, the preset particle size may be not less than 5 mm and less than 50 mm. Thus, in the present embodiments, the raw material containing iron oxide having a particle size smaller than a preset particle size is a raw material containing iron ore having a particle size of less than 5 mm, or return ore having a particle size of less than 5 mm produced in a sintered ore production process. The raw material may contain a metal oxide such as silicon dioxide, calcium oxide, or aluminum oxide, and a non-ferrous material in addition to iron oxide as the main component. The total amount of the metal oxide other than iron oxide, the non-ferrous material, etc. is preferably not more than 20% by mass of the raw material. In the present embodiments, the particle size is determined by a screen; for example, iron ore having a particle size of less than 5 mm refers to iron ore which is screened out by a 5 mm-mesh screen.

In the agglomerated raw material production method of the present embodiments, the raw material is agglomerated by heating it at a target temperature while pressing it at a target pressure. Thus, the raw material is agglomerated by increasing the temperature of the raw material to the target temperature while increasing the pressure applied to the raw material to the target pressure. The pressure and temperature of the raw material may be increased to their target values substantially simultaneously. Alternatively, the raw material may be agglomerated by increasing the temperature of the raw material to the target temperature when the target pressure of the raw material has been reached, or the raw material may be agglomerated by increasing the pressure of the raw material to the target pressure when the target temperature of the raw material has been reached. The target pressure and the target temperature are a pressure and a temperature at which the raw material can be agglomerated and which can be experimentally determined. For example, the pressure may be determined by measuring the pressure in a container filled with the raw material using a conventionally known pressure sensor, or may be calculated based on a load applied to the container to apply a pressure to the raw material. The temperature may be determined by measuring the temperature in the container filled with the raw material using a temperature sensor provided on the inner wall of the container.

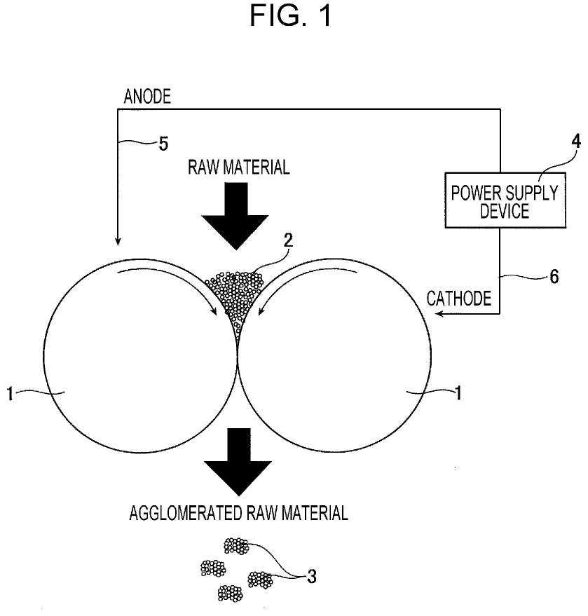

The raw material may be pressed by any conventionally known pressing method, for example, a double-roll method. FIG. 1 is a diagram schematically showing an example of a double-roll type pressure device to which an agglomerated raw material production method according to an embodiment of the disclosure can be applied. As shown in FIG. 1, the double-roll type pressure device includes a pair of rolls 1 disposed with a predetermined clearance (not shown) therebetween and having a plurality of molds (not shown), each corresponding to the shape of a half of a molded product, formed in their peripheral surfaces. A raw material 2 is filled into molds of the rolls 1, and the raw material 2 is pressed as the rolls 1 rotate and the molds of the rolls 1 approach each other. Alternatively, the raw material 2 may be pressed using, instead of such a double-roll type pressure device, a tablet-compression method which involves filling the raw material 2 into a space formed by a mold and a punch, and compression-molding the raw material 2 by pushing the punch into the space.

The raw material 2 may be heated using an electric furnace; however, it is preferred to heat the raw material 2 mainly by electrical heating. Electrical heating is a method which involves applying an electric current to a raw material to heat it. In the double-roll type pressure device shown in FIG. 1, an anode 5 and a cathode 6 of a power supply device 4 are connected to one and the other, respectively, of the rolls 1. The double-roll type pressure device shown in FIG. 1 is thus configured to be capable of electrically heating the raw material 2 while pressing it.

Induction heating is a method which involves placing the raw material 2 in a magnetic field, generated by applying an alternating current to a conducting wire, to cause an electric current in the raw material 2, thereby heating the raw material 2. Thus, induction heating likewise heats the raw material 2 by allowing electricity to flow through the raw material 2. The electrical heating according to the present embodiments therefore includes not only direct electrical heating but induction heating as well. In the double-roll type pressure device shown in FIG. 1, a magnetic field is generated around it to cause an electric current in the raw material 2, thereby heating the raw material 2. The phrase “heat the raw material 2 mainly by electrical heating” means that when the raw material 2 is heated using electrical heating and other heating method(s) in combination, the amount of heat generated in the raw material 2 by the electrical heating is at least 50% of the total heat generated in the raw material 2. The “other heating method(s)” includes, for example, heating in an electric furnace, and heating of the raw material with heat generated upon the combustion of a given fuel.

As described above, according to the agglomerated raw material production method of the present embodiments, the raw material 2 is heated while its particles are being pressed or compressed to each other. Thus, heating of the raw material 2 can be performed with the contact areas of the particles increased as compared to heating of non-pressed raw material 2. This promotes binding between particles of the raw material 2, making it possible to agglomerate the raw material 2 at a lower temperature than that in agglomeration of non-pressed raw material 2 even though the raw material 2 contains 50% by mass or more of iron oxide which is difficult to agglomerate.

In the agglomerated raw material production method of the present embodiments, it is preferred to add a granular or powdered metal, which deforms plastically and has a higher electrical conductivity than iron, to the raw material 2 in order to facilitate the agglomeration of the raw material 2. The additive metal to be added to the raw material 2 is, for example, copper, iron, or niobium. When the raw material 2 to which such a metal has been added is pressed and heated in the above-described manner, the additive metal is pressed by the raw material 2 and deforms plastically. Particles of the raw material 2 are brought into close contact with each other via the plastically deformed additive metal, whereby the particles are strongly bound together. Thus, the additive metal functions as a binder. Therefore, compared with the case where the raw material 2 contains no additive metal, particles of the raw material 2 can be bound together at a lower temperature to obtain an agglomerated raw material 3.

As the amount of the additive metal in the raw material 2 increases, the amount of iron oxide to be reduced decreases. Since the agglomerated raw material 3 is used as a raw material in a pig iron production process that performs gas reduction of the raw material, a decrease in the amount of iron oxide contained in the agglomerated raw material 3 is undesirable. Therefore, it is preferred to use the raw material 2 containing more than 50% by mass of iron oxide, and to use the additive metal in the smallest possible amount. Further, while the additive metal deforms plastically and binds particles of the raw material 2 together, it fills gaps between particles of the raw material 2. Therefore, if the amount of the additive metal is too large, the gas permeability of the agglomerated raw material 3 will be low, leading to low reducibility of the raw material. Therefore, the amount of the additive metal is preferably as small as possible. For the above reasons, the amount of the additive metal may be not less than 10% by mass and less than 50% by mass, preferably not less than 10% by mass and not more than 30% by mass.

When the raw material 2 is electrically heated while it is being pressed, electricity flows along the surface of iron oxide. Electricity flows to contact portions of particles of the raw material 2, and therefore the contact portions are heated and their temperatures are raised, whereby the particles of the raw material 2 are bound together and agglomerated. Due to the pressure applied to the raw material 2, its particles are brought close to each other with narrow gaps between them. The raw material 2 is directly heated electrically, with air present in the gaps. Specifically, the potential difference between the electrodes is increased. Iron oxide, which is an insulator, and the above-described air exist between the electrodes. It is conceivable that the potential difference breaks down the insulation of the air, allowing electricity to flow along the surface of the raw material 2. In the case of induction heating, it is conceivable that a magnetic field, generated by applying an alternating current to a conducting wire, generates an electric current, so that electricity flows along the surface of the raw material 2.

When the raw material 2 contains the above-described additive metal, electricity flows to the additive metal, and a high amount of heat (Joule heat) is generated by the metal. Accordingly, compared with the case where the raw material 2 contains no additive metal, a higher amount of heat (Joule heat) is generated at contact portions of particles of the raw material 2, and the particles are bound together and agglomerated. Since heat is generated mainly by the additive metal, particles of the raw material 2 can be bound together and agglomerated without heating the entire raw material 2 to a target temperature. In other words, particles of the raw material 2 can be bound together and agglomerated at a lower averaged temperature of the entire raw material 2 containing the additive metal. Thus, by electrically heating the raw material 2, particles of the raw material 2 can be bound together and agglomerated without heating the entire raw material 2. This can reduce the energy consumption required to agglomerate the raw material 2. In addition, the reduction in the heating temperature can facilitate heating of the raw material and can reduce the heat resistance of a mold(s) required for the agglomeration of the raw material.

An agglomeration agent, such as coke powder, is conventionally used in the production of an agglomerated ore which is to be used as a raw material in a blast furnace or a shaft furnace; the ore is agglomerated through combustion of the agglomeration agent. On the other hand, in the agglomerated raw material production method of the present embodiments, an agglomerated ore can be produced by heating using an electric furnace or by electrical heating. The present production method has the advantage of being capable of reducing the generation of CO2 associated with the combustion of an agglomeration agent.

The agglomerated raw material production method of the present embodiments will now be described in more detail by reference to experimental examples in which agglomerated raw materials were produced on a laboratory scale.

### Experimental Example 1

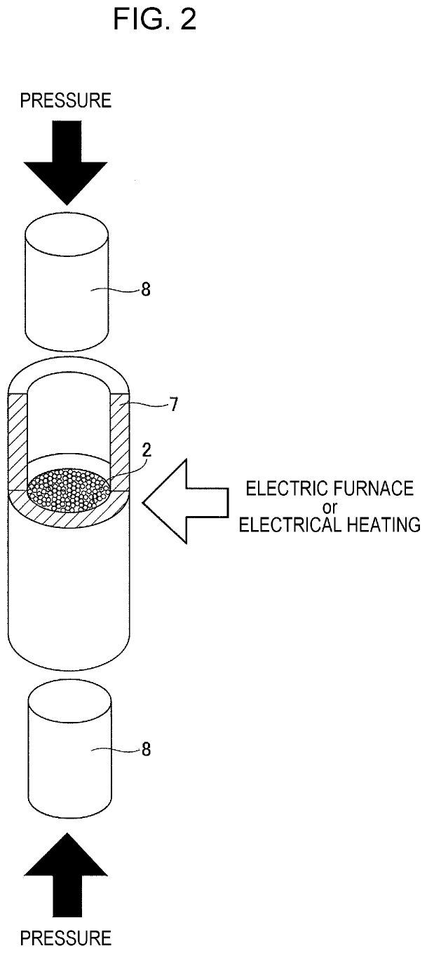

Return ore having a particle size of less than 5 mm were used as a raw material. The component composition of the return ore was as follows: Fe₂O₃ 74.8% by mass, FeO 7.0% by mass, SiO₂ 5.0% by mass, CaO 10.0% by mass, Al₂O₃ 1.5% by mass, and the balance being incidental impurities. The T. Fe was 57.7% by mass. FIG. 2 is a diagram showing a mold used in Experimental Example 1. The mold 7 shown in FIG. 2 has a cylindrical shape. The raw material was filled into the mold 7, and punches 8 having a cylindrical shape were inserted into the mold 7 through openings formed at both axial ends of the mold 7 to seal the raw material. Since the mold 7 and the punches 8 are to be heated to about 1100° C., they are made of a heat-resistant material. The punches 8 are required to conduct electricity upon its electrical heating; therefore, they are made of a conductive material.

Subsequently, the raw material was pressed to a target pressure and kept at the pressure. In Experimental Example 1, the raw material was pressed by pressing the punches 8 using Autograph (registered trademark). The pressure applied to the raw material was calculated based on the compressive load applied by the Autograph (registered trademark) and on the cross-sectional area of the mold 7. In Experimental Example 1, the raw material was pressed by pressing the punches 8 at a compressive load corresponding to the target pressure.

Thereafter, the mold 7 containing the raw material was heated to a predetermined target temperature. In Experimental Example 1, the temperature of the mold 7 was raised to the target temperature at a heating rate of 200° C./min in an electric furnace. After the target temperature was reached, the pressure and temperature conditions were maintained for about 5 minutes. A determination as to whether the target temperature has been reached was made by measuring the temperature of the inner surface of the mold 7 using a not-shown thermometer provided on the inner surface, and comparing the measured temperature with the target temperature.

After 5 minutes, the raw material was taken from the mold 7, and the raw material was evaluated for its agglomeration. In particular, the agglomerated raw material, which had been taken from the mold 7, was dropped from a height of 1.0 m, and whether it was broken or not was visually determined. When the agglomerated raw material, which had been taken from the mold 7, was broken or chipped due to the impact of the drop, the raw material was determined to be non-agglomerated. The heating temperature and pressure of the raw material, and the results of the evaluation of agglomeration are shown in Table 1 below. In Table 1 and subsequent tables, “O” indicates that the raw material was agglomerated, and “X” indicates that the raw material was not agglomerated.

TABLE 1

| | Temperature | Pressure | |
|---|---|---|---|
| | (° C.) | (MPa) | Agglomeration |
| Inventive Example 1 | 1100 | 20 | ∘ |
| Comp. Example 1 | 1000 | 20 | x |
| Comp. Example 2 | 900 | 20 | x |
| Comp. Example 3 | 700 | 20 | x |
| Inventive Example 2 | 900 | 40 | ∘ |
| Comp. Example 4 | 700 | 40 | x |

As shown in Table 1, in Experimental Example 1, the raw material was agglomerated under the conditions of a pressure of 20 MPa and a heating temperature of 1100° C. On the other hand, even at a pressure of 20 MPa, the raw material was not agglomerated when the heating temperature was less than 1100° C. When the pressure was 40 MPa, the raw material was agglomerated even at a heating temperature of 900° C., which is less than 1100° C. The following inequality (1) can be derived from the results of Inventive Examples 1 and 2 in Table 1. Thus, the data indicates that there is a correlation between a pressure and a heating temperature, at which the raw material is agglomerated; the raw material is agglomerated when the pressure and temperature, applied to the raw material, satisfy the following inequality (1).

$$P \geq 40 - ( T - 900 ) / 10 \qquad ( 1 )$$

In the inequality (1), P is a pressure (MPa) at which the raw material is pressed, and T is a temperature (° C.) at which the raw material is heated. When a predetermined pressure is applied to the raw material, the lowest temperature for achieving agglomeration of the raw material can be determined by determining the minimum value of T that satisfies the inequality (1). Similarly, when the raw material is heated at a predetermined temperature, the lowest pressure for achieving agglomeration of the raw material can be determined by determining the minimum value of P that satisfies the inequality (1).

### Experimental Example 2

In Experimental Example 2, metallic iron was added to the raw material of Experimental Example 1. The metallic iron refers to non-oxidized iron, and in Experimental Example 2, metallic iron having a particle size of about 150 μm or less and a purity of 90% by mass was added to the raw material. After thoroughly stirring and mixing the raw material and the metallic iron, they were filled into the mold 7. The heating temperature and pressure of the raw material, the amount of metallic iron, and the results of the evaluation of agglomeration in Experimental Example 2 are shown in Table 2 below. Heating and pressing of the raw material were performed by the same procedure as that of Experimental Example 1.

TABLE 2

| | | | Amount of | |
|---|---|---|---|---|
| | | | metallic iron | |
| | Temper- | | (mass % | |
| | ature | Pressure | (included | |
| | (° C.) | (MPa) | in total)) | Agglomeration |
| Inventive Example 3 | 1100 | 20 | 10 | ∘ |
| Inventive Example 4 | 1000 | 20 | 10 | ∘ |
| Inventive Example 5 | 1000 | 20 | 20 | ∘ |
| Comp. Example5 | 900 | 20 | 10 | x |

As shown in Table 2, in Inventive Example 4 of Experimental Example 2, the raw material was agglomerated under the conditions of a pressure of 20 MPa and a heating temperature of 1000° C. The result indicates that by adding 10% by mass of metallic iron to the raw material, the heating temperature for achieving agglomeration of the raw material can be made lower by 100° C. than that in Inventive Example 1 of Experimental Example 1. Also, in Inventive Example 5 in which the amount of metallic iron was increased to 20% by mass, the raw material was agglomerated under the conditions of a pressure of 20 MPa and a heating temperature of 1000° C. This indicates that metallic iron may be added to the raw material in an amount of 10% by mass or more.

These results are considered to be due to the fact that the metallic iron was pressed and plastically deformed by pressing and heating of the raw material, and the plastically deformed metallic iron functioned as a binder, so that particles of the raw material were bound together and agglomerated via the metallic iron. Thus, the reduction in the temperature for achieving agglomeration of the raw material is considered to be due to the metallic iron having functioned as a binder.

### Experimental Example 3

In Experimental Example 3, agglomeration of the raw material was performed by the same procedure as that of Experimental Example 1 except that the raw material was filled into the mold 7 under a nitrogen atmosphere, and that the temperature of the raw material was raised at a rate of 200° C. per minute to a target temperature by electrical heating instead of electric furnace heating. In Experimental Example 3, an anode 5 and a cathode 6 were connected to the punches 8 inserted into the openings at both ends of the mold 7, and 3 kWh of pulsed power was applied from a power supply device 4 under a nitrogen atmosphere to electrically heat the raw material. The heating temperature and pressure of the raw material 2, and the results of the evaluation of agglomeration in Experimental Example 3 are shown in Table 3 below.

TABLE 3

| | Temper- | | | |
|---|---|---|---|---|
| | ature | Pressure | | Agglom- |
| | (° C.) | (MPa) | Heating method | eration |
| Inventive Example 6 | 1100 | 20 | Electrical heating | ∘ |
| Inventive Example 7 | 900 | 20 | Electrical heating | ∘ |
| Inventive Example 8 | 700 | 40 | Electrical heating | ∘ |
| Ref. Example 1 | 700 | 20 | Electrical heating | x |
| Ref. Example 2 | 500 | 20 | Electrical heating | x |

As shown in Table 3, in Inventive Example 7 of Experimental Example 3, the raw material was agglomerated under the conditions of a pressure of 20 MPa and a heating temperature of 900° C. The result indicates that by heating the raw material by electrical heating, the heating temperature for achieving agglomeration of the raw material can be made lower by 200° C. than that in Inventive Example 1 of Experimental Example 1. Similarly, in Inventive Example 8 of Experimental Example 3, the raw material 2 was agglomerated under the conditions of a pressure of 40 MPa and a heating temperature of 700° C. This indicates that the heating temperature for achieving agglomeration of the raw material can be made lower by 200° C. than that in Inventive Example 2 of Experimental Example 1.

When the raw material is heated electrically, the insulation of air, existing in gaps between particles of the raw material 2, is broken down due to the potential difference between the electrodes 5 and 6, and electricity flows along the surface of the raw material. The Joule heat generated by the flow of electricity selectively heats the surface of the raw material. Though the average temperature of the entire raw material is low, particles of the raw material are bound together at their surfaces whose temperatures are locally high. This may explain the reduction in the agglomeration temperature.

The following inequality (2) can be derived from the results of Inventive Examples 7 and 8 shown in Table 3. Thus, the data indicates that in the case of electrical heating of the raw material 2, the raw material is agglomerated when the pressure and temperature, applied to the raw material, satisfy the following inequality (2).

$$P \geq 40 - ( T - 700 ) / 10 \qquad ( 2 )$$

In the inequality (2), P is a pressure (MPa) at which the raw material is pressed, and T is a temperature (° C.) at which the raw material is heated. The lowest temperature for achieving agglomeration of the raw material can be determined by determining the minimum value of T that satisfies the inequality (2).

### Experimental Example 4

In Experimental Example 4, agglomeration of the raw material was performed by the same procedure as that of Experimental Example 3 except that metallic iron, metallic copper, or metallic niobium was added to the raw material. The heating temperature and pressure of the raw material, the amount of metallic iron, and the results of the evaluation of agglomeration in Experimental Example 4 are shown in Table 4 below.

TABLE 4

| | | | | Type and | |
|---|---|---|---|---|---|
| | | | | amount of metal | |
| | | | | (mass % | |
| | Temperature | Pressure | Heating | (included in | |
| | (° C.) | (MPa) | method | total)) | Agglomeration |
| Inventive | 700 | 20 | Electrical | Metallic iron | ∘ |
| Example 9 | | | heating | 10 | |
| Inventive | 700 | 20 | Electrical | Metallic iron | ∘ |
| Example 10 | | | heating | 20 | |
| Inventive | 700 | 20 | Electrical | Metallic copper | ∘ |
| Example 11 | | | heating | 10 | |
| Ref. | 700 | 20 | Electrical | Metallic niobium | x |
| Example 3 | | | heating | 10 | |

As shown in Table 4, in Inventive Example 9 of Experimental Example 4, the raw material was agglomerated under the conditions of a pressure of 20 MPa and a heating temperature of 700° C. The result indicates that by adding 10% by mass of metallic iron to the raw material and by electrically heating the raw material, the heating temperature for achieving agglomeration of the raw material can be made lower by 400° C. than that in Inventive Example 1 of Experimental Example 1. Also, in Inventive Example 10 in which the amount of metallic iron was 20% by mass, the raw material was agglomerated under the conditions of a pressure of 20 MPa and a heating temperature of 700° C. This indicates that metallic iron may be added to the raw material in an amount of 10% by mass or more also in the case of electrically heating the raw material.

In Inventive Example 11 in which 10% by mass of metallic copper was added to the raw material, the raw material was agglomerated under the conditions of a pressure of 20 MPa and a heating temperature of 700° C. On the other hand, in Reference Example 3 in which 10% by mass of metallic niobium was added to the raw material, the raw material was not agglomerated under the conditions of a pressure of 20 MPa and a heating temperature of 700° C.

The amount of heat generated by electrical heating can be calculated by the following equation (4).

$$Q = {V}^{2} / R \qquad ( 4 )$$

In the equation (4), Q is the amount of heat (J) generated, V is a voltage (V), and R is an electrical resistance (Ω).

As can be seen from the equation (4), the amount of heat generated by electrical heating is higher for a metal having a relatively high electrical conductivity than for a metal having a relatively low electrical conductivity when the same voltage is applied to the metals. Considering that the electrical conductivity of iron is 11×10⁶ S/m, the electrical conductivity of copper is 64×10⁶ S/m, and the electrical conductivity of niobium is 7×10⁶ S/m, it can be said that the electrical conductivity of a metal for use as an additive metal is preferably at least 11×10⁶ S/m which is the electrical conductivity of iron. The binder effect of a metal is achieved regardless of its electrical conductivity. Therefore, even when 10% by mass of metallic niobium is added to the raw material, the raw material can be agglomerated under the conditions of a pressure of 20 MPa and a heating temperature of 900° C.

The following inequality (3) can be derived from the results of Inventive Examples 9 to 11 shown in Table 4. Thus, the data indicates that in the case where the raw material contains 10% by mass or more of a metal which deforms plastically and has an electrical conductivity of 11×10⁶ S/m or more, and the raw material is heated by electrical heating, the raw material is agglomerated when the pressure and temperature, applied to the raw material, satisfy the following inequality (3).

$$P \geq 40 - ( T - 500 ) / 10 \qquad ( 3 )$$

### Experimental Example 5

In Experimental Example 5, agglomeration of a raw material was performed by the same procedure as that of Experimental Example 3 or Experimental Example 4 except that the raw material used had a component composition different from that of the raw material used in Experimental Examples 1 to 4. The heating temperature and pressure of the raw material, the amount of metallic iron, and the results of the evaluation of agglomeration in Experimental Example 5 are shown in Table 5 below. The raw material used in Experimental Example 5 had an average particle size of not more than 1.0 mm and had the following component composition: Fe₂O₃ 81.3% by mass, FeO 11.6% by mass, SiO₂ 4.2% by mass, Cao 0.4% by mass, Al₂O₃ 0.2% by mass, and the balance being incidental impurities. The T. Fe was 65.9% by mass. The raw material used in Experimental Example 5 was iron ore powder containing almost no calcium oxide.

The iron ore powder containing no metallic iron or the raw material containing metallic iron was prepared and filled into the mold 7 under a nitrogen atmosphere, and was heated by electrical heating at a rate of 200° C. per minute to a target temperature. The heating temperature and pressure of the raw material, the amount of metallic iron, and the results of the evaluation of agglomeration in Experimental Example 5 are shown in Table 5 below.

TABLE 5

| | | | | Amount of | |
|---|---|---|---|---|---|
| | | | | metallic | |
| | Temper- | Pres- | | iron (mass % | |
| | ature | sure | Heating | (included | Agglom- |
| | (° C.) | (MPa) | method | in total)) | eration |
| Inventive | 900 | 20 | Electrical | 0 | ∘ |
| Example 12 | | | heating | | |
| Ref. | 700 | 20 | Electrical | 0 | x |
| Example 1 | | | heating | | |
| Inventive | 700 | 20 | Electrical | 10 | ∘ |
| Example 13 | | | heating | | |

As shown in Table 5, in Examples 12 and 13, the iron ore was agglomerated even though it contained almost no calcium oxide that functions as a binder upon the granulation of iron ore powder. It was confirmed by the results that as with the raw material containing calcium oxide, even the raw material containing no calcium oxide can be agglomerated by the hot press. It was also confirmed by the results of Example 13 that as with the raw material containing calcium oxide, even the raw material containing no calcium oxide can be agglomerated under the conditions of a pressure of 20 MPa and a heating temperature of 700° C. by adding 10% by mass of metallic iron to the raw material.

As described hereinabove, according to the agglomerated raw material production method of the present embodiments, a raw material containing iron oxide can be agglomerated at a lower temperature than the conventional methods. This can reduce the energy consumption required to agglomerate the raw material. Further, by using electric furnace heating or electrical heating, a raw material can be heated without adding an agglomeration agent, such as coke powder, to the raw material and combusting the agglomeration agent. This can reduce the amount of carbon dioxide generated upon the production of an agglomerated raw material.

### REFERENCE SIGNS LIST

1 roll of a double-roll type pressure device
2 raw material containing iron oxide
3 agglomerated raw material
4 power supply device
5 anode
6 cathode
7 mold
8 punch

1. A method for producing an agglomerated raw material, comprising pressing and heating a raw material containing iron oxide having a particle size smaller than a preset particle size, thereby agglomerating the raw material,
wherein the raw material contains the iron oxide in an amount of more than 50% by mass, and
wherein the raw material is heated by electrical heating.

2. The method for producing an agglomerated raw material according to claim 1,
wherein the raw material contains 10% by mass or more of a metal which deforms plastically during the pressing and heating.

3. The method for producing an agglomerated raw material according to claim 2,
wherein the raw material is agglomerated by heating it at 700° C. or more while pressing it at 20 MPa or more.

4. The method for producing an agglomerated raw material according to claim 2,
wherein the metal has an electrical conductivity of 11×10⁶ S/m or more.

5. A method for producing an agglomerated raw material, comprising pressing and heating a raw material containing iron oxide having a particle size smaller than a preset particle size, thereby agglomerating the raw material,
wherein the raw material contains the iron oxide in an amount of more than 50% by mass, and
wherein a pressure at which the raw material is pressed and a temperature at which the raw material is heated satisfy the following inequality (1):
$$P \geq 40 - ( T - 900 ) / 10 \qquad ( 1 )$$
where P is the pressure (MPa), and T is the temperature (° C.).

6. A method for producing an agglomerated raw material, comprising pressing and heating a raw material containing iron oxide having a particle size smaller than a preset particle size, thereby agglomerating the raw material,
wherein the raw material contains the iron oxide in an amount of more than 50% by mass, and
wherein when the heating of the raw material is electrical heating, a pressure at which the raw material is pressed and a temperature at which the raw material is heated satisfy the following inequality (2):
$$P \geq 40 - ( T - 700 ) / 10 \qquad ( 2 )$$
where P is the pressure (MPa), and T is the temperature (° C.).

7. The method for producing an agglomerated raw material according to claim 1,
wherein the raw material contains 10% by mass or more of a metal which deforms plastically during the pressing and heating and has an electrical conductivity of 11×10⁶ S/m or more, and
wherein a pressure at which the raw material is pressed and a temperature at which the raw material is heated satisfy the following inequality (3):
$$P \geq 40 - ( T - 500 ) / 10 \qquad ( 3 )$$
where P is the pressure (MPa), and T is the temperature (° C.).

8. The method for producing an agglomerated raw material according to claim 3,
wherein the metal has an electrical conductivity of 11×10⁶ S/m or more.
